(19) United States
(12) Patent Application Publication
(10) Pub. No.: US 2018/0357918 A1
(43) Pub. Date: Dec. 13, 2018

(54) SYSTEM AND METHOD OF ITERATING GROUP-BASED TUTORIAL CONTENT

(71) Applicant: Abbott Cardiovascular Systems, Santa Clara, CA (US)

(72) Inventors: Natalya Shpolyansky, Campbell, CA (US); Michael Saso, San Jose, CA (US); Amelia Aliota-Davalle, Houston, TX (US)

(21) Appl. No.: 16/108,046

(22) Filed: Aug. 21, 2018

Related U.S. Application Data
(63) Continuation of application No. 14/053,081, filed on Oct. 14, 2013, now abandoned.

(51) Int. Cl. G09B 7/08

(52) U.S. Cl. CPC G09B 7/08

(57) ABSTRACT

A system for providing post-operative instructions to patients for discharge from a medical facility comprising a repository of instructions consisting of patient-anonymous data and a graphical user interface, the graphical user interface operative for selecting at least one instruction from the repository to assemble a tutorial. The system includes a memory for storing the tutorial, each tutorial associated with a particular user profile and a display, the display presenting the tutorial to the patient. The system further includes a questionnaire to assess patient comprehension of the tutorial, and a calendar module, the calendar module configured to schedule reminder notifications for communication to the patient. An analytics module is also provided, the analytics module configured to analyze patient questionnaire responses and determine optimal tutorial content.

This application is a continuation of co-pending U.S. application Ser. No. 14/053,081 filed on Oct. 14, 2013, which application is incorporated herein by reference.

### BACKGROUND OF THE DISCLOSED SUBJECT MATTER

### Field of the Disclosed Subject Matter

The disclosed subject matter relates to a system for patient communication and interfacing. Particularly, the present disclosed subject matter is directed toward an interface for communicating instructions and information to patients at time of discharge from a medical facility.

### Description of Related Art

Avoidable patient readmissions are a result of a fragmented health care system that too often leaves discharged patients confused about how to care for themselves at home, unable to follow instructions and get the necessary follow-up care. Readmissions are also a costly price to pay for a health care system that does not have resources to spare. It has been reported that Medicare alone reports spending $17.8 billion a year on patients whose return trips to the hospital should have been avoided. Indeed, as noted in US. Patent Application Publication No. 2011/0131060, the entire contents of which are hereby incorporated by reference, approximately 19% of patients are readmitted to a medical facility within 30 days of original discharge. Accordingly, helping people who were recently released from a hospital understand how to care for themselves and informing their primary care doctors about their stay may reduce their risk of being admitted back into the hospital.

As evident from the current readmission rates, conventional methods of educating and informing patients on the risks associated with their particular procedure, as well as their responsibilities for preventative care and/or medical regime adherence, are inadequate or simply not fully comprehended by patients.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a method of presenting instructions to at least one patient comprising providing a repository of instructions, the instructions consisting of patient-anonymous data; selecting at least one instruction from said repository; assembling a tutorial from selected instructions; presenting the tutorial to a patient prior to discharge from a medical facility; administering at least one questionnaire to the patient to assess patient comprehension of said tutorial; analyzing patient questionnaire responses; and determining optimal tutorial content.

The system and interface presented herein allows for modifying the selected instructions within a tutorial to exhibit the optimal content, either manually by a caregiver or medical facility representative or automatically.

In an exemplary embodiment, the instructions are directed towards a post-operative medical treatment and include graphical content, audio content, animated content, or combinations thereof. The instructions can be displayed on a hand held device, or sent electronically to be viewed remotely.

The tutorial can be configured with a first presentation for a first patient and a different presentation for a second patient. Additionally, the system disclosed herein can comprise sending an email to the patient or patient's caregiver (the email including a URL address to the tutorial) as well as sending a copy of the email to a physician or medical facility. In some embodiments the instructions are presented in multiple languages and include prescription information, nutritional information and/or educational information.

In accordance with another aspect of the disclosed subject matter, a system for providing post-operative instructions to patients for discharge from a medical facility is provided which comprises a repository of instructions consisting of patient-anonymous data; a graphical user interface, the graphical user interface operative for selecting at least one instruction from the repository to assemble a tutorial; a memory for storing the tutorial, each tutorial associated with a particular user profile; a display, the display presenting the tutorial to the patient; a questionnaire to assess patient comprehension of the tutorial; a calendar module, the calendar module configured to schedule reminder notifications for communication to the patient; and an analytics module, the analytics module configured to analyze patient questionnaire responses and determine optimal tutorial content.

In some embodiments, a first user profile includes a customized tutorial for a first patient, and a second user profile includes a customized tutorial for a second patient. Additionally, an email agent for sending a message to the patient or patient's caregiver can be provided, the message including a URL address to the tutorial and the email agent is configured to send a copy of the message to a physician or medical facility.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is an exemplary representation of a schematic graphical instruction provided to a patient in accordance with the disclosed subject matter.

FIG. 2 is an exemplary representation of a schematic pictorial instruction provided to a patient in accordance with the disclosed subject matter.

FIG. 3 is an exemplary flowchart of an interface system in accordance with the disclosed subject matter.

FIG. 4 is an exemplary representation of an interface for accessing the instruction repository or library provided to medical personnel in accordance with the disclosed subject matter.

FIG. 5 is an exemplary representation of an interface for selecting instructions from the repository or library provided to medical personnel to assemble a patient tutorial in accordance with the disclosed subject matter.

FIG. 6 is an exemplary representation of an interface with particular instructions selected by the medical personnel in accordance with the disclosed subject matter.

FIG. 7 is an exemplary representation of an interface for generating a tutorial by medical personnel in accordance with the disclosed subject matter.

FIG. 8 is an exemplary representation of an animated tutorial presented to the patient in accordance with the disclosed subject matter.

FIG. 9 is an exemplary representation of an interface for generating a graphical tutorial and reporting option in accordance with the disclosed subject matter.

FIG. 10 is an exemplary representation of an interface for generating an electronic mail for providing a copy of the tutorial to patients in accordance with the disclosed subject matter.

FIG. 11 is an exemplary representation of an interface for generating a tutorial template by medical personnel in accordance with the disclosed subject matter.

FIG. 12 is an exemplary representation of an interface for viewing a tutorial on a remote device in accordance with the disclosed subject matter.

FIG. 13 is an exemplary representation of an interface for generating a read receipt by medical personnel in accordance with the disclosed subject matter.

FIG. 14 is an exemplary representation of an interface for scheduling reminder notifications for patients in accordance with the disclosed subject matter.

### DETAILED DESCRIPTION OF AN EXEMPLARY EMBODIMENT

Reference will now be made in detail to exemplary embodiments of the disclosed subject matter, an example of which is illustrated in the accompanying drawings. The method and corresponding steps of the disclosed subject matter will be described in conjunction with the detailed description of the system.

The system and method described herein provides numerous benefits over conventional patient discharge methodologies. Presently, patients are required to read extensive instructions presented on numerous forms prior to discharge from a medical facility. Often the forms presented to the patient include esoteric medical terminology and legal boiler plate language which distract patients thereby reducing comprehension. Additionally, some forms include extraneous information not pertinent to the procedure(s) underwent by the patient and/or outdated information which only further distracts the patient Consequently, patients fail to comprehend and/or retain the information presented in these forms. This is particularly applicable to the elderly and non-english speaking populations.

Accordingly, the presently disclosed subject matter aims to improve compliance and success with post-procedure care in order to reduce patient readmission rates. Additionally, the system disclosed herein can improve follow up efficiency through automated, post-procedure monitoring and health management. The interactive patient tutorial system can reduce potentially adverse outcomes by improving patient comprehension, regimen compliance and early notification, thereby enabling early intervention. This can decrease unnecessary post-procedure, emergency room, and hospital admissions, which could lead to thousands of dollars in savings to patients and the healthcare system. Additionally, the system disclosed herein can build patient loyalty and retention by offering automated follow up and secure messaging.

Certain embodiments are described herein with reference to drawing figures that show examples of graphical user interface screen displays. However, each of the drawing figures merely provides one example, and other embodiments may use other screen displays with different formats, layouts, graphics, text, and/or arrangements of GUI widgets that are functionally similar or functionally different.

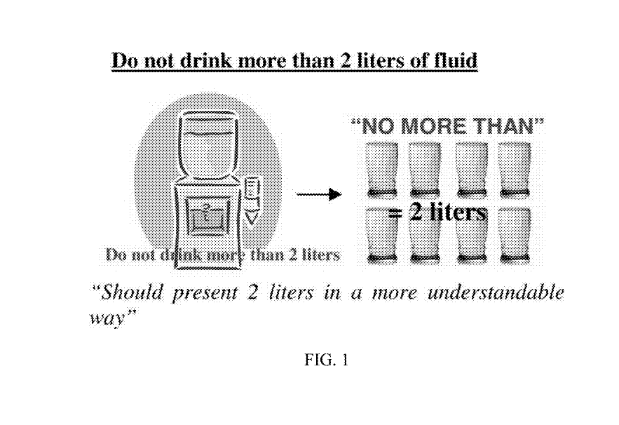

As shown in FIG. 1, the system generally includes an interface for displaying patient follow up care instructions in a concise and graphical format to increase patient comprehension and facilitate the discharge process. Rather than present the patient with a text based instructions spanning multiple pages, and multiple forms, the system and method disclosed herein reproduces the instructions in a user-friendly and easily comprehendible graphical depiction. The exemplary embodiment shown in FIG. 1 depicts instructions related to patient nutrition, however it is to be understood that the present disclosure applies to any category of instructions (e.g. surgical treatments, prescription regimens and nutritional information) wherein traditionally alpha-numeric text based instructions can be converted into graphical depictions to simplify and expedite the discharge process. The example depicted in FIG. 1 demonstrates the utility of the disclosure in that rather than require a patient to understand what 2 liters of fluid amounts to in the abstract, the instruction can be provided via an image which demonstrates how many cups that equates to. Thus, the interface provides the necessary information/instruction, but presents it in a more user friendly and practical manner in that it is focused on the patient's every day activities (e.g. drinking individual cups of water) rather than the instruction itself (e.g. do not consume more than 2 gallons). Consequently, the system disclosed herein facilitates patient comprehension by allowing the patient to gauge what is permissible (in this instance what is less than 2 gallons) and what is not.

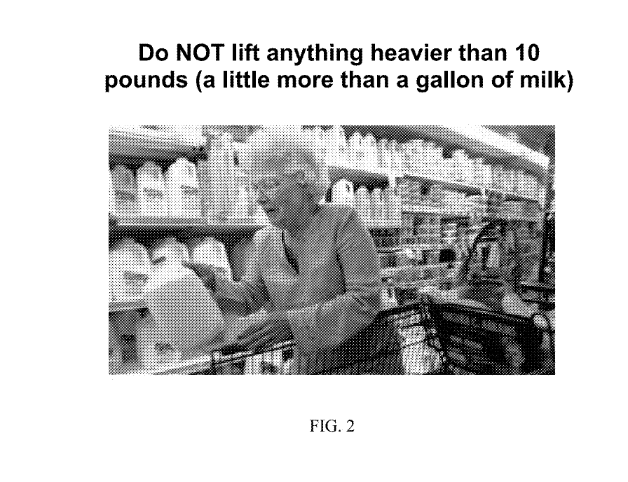

Similarly, FIG. 2 demonstrates another example of providing patient-focused instruction rather than a rule-focused instruction in that the picture provided to the patient both conveys the instruction (i.e. do not lift more than 10 lbs.) and a visual representation of that instruction (i.e. nothing heavier than a gallon of milk). This visual representation allows the patient to more easily understand the instruction and thereby increases the patient's likelihood to comply with the instruction, which in turn leads to improved post-operative treatment, compliance and reduced likelihood of readmission.

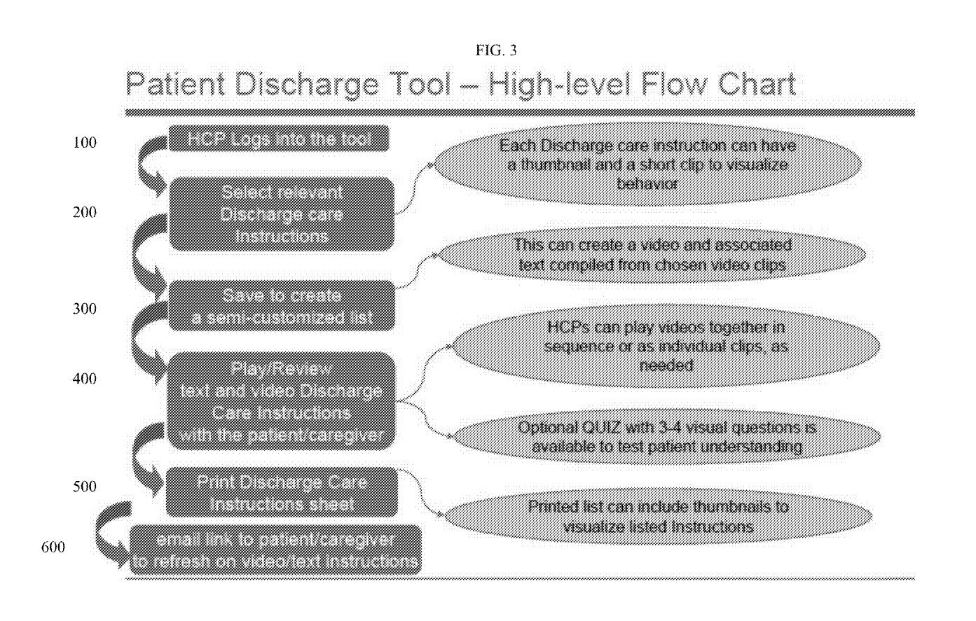

FIG. 3 depicts a representative flowchart of an exemplary embodiment of the disclosed subject matter. In step 100 the health care practitioner (HCP) logs into the tool, i.e. uses the user interface to create or log into an existing account. The user interface environment can be configured with a variety of depictions to suit the particular HCP or medical facility. For example, the display of the login screen may include a name, trademark, logo, or other graphical symbol of a HCP or medical facility that owns or operates the servers or the application logic with which the user interface communicates. In step 200 the HCP can select discrete instructions from a repository or library of available instructions in order to configure or build a patient tutorial. The library of discrete instructions can be populated, and updated, wirelessly or via wireline by the HCP.

Significantly, the repository of instructions consists of patient-anonymous data. In other words, the instructions do not include any confidential medical data such as patient's medical history, names, DOBs, social security numbers, etc. This is advantageous in that the instructions, and overall patient discharge system disclosed herein, is compliant with the Health Insurance Portability and Accountability Act (HIPAA) which protects the privacy of individually identifiable health information. By virtue of containing only patient anonymous data, any tutorial generated from the library of instructions within the disclosed system inherently complies with the national standards for the security of electronic protected health information required by HIPAA. Additionally, such patient anonymous data reduces the complexity and costs and capacity demands on the health care practitioner/provider as there is no need to hash, salt, or otherwise encrypt the data. Moreover, the absence of patient-specific data eliminates any risk of a HIPPA breach, and thus shields the health care practitioner/provider ever having to comply with HIPAA Breach Notification Rule.

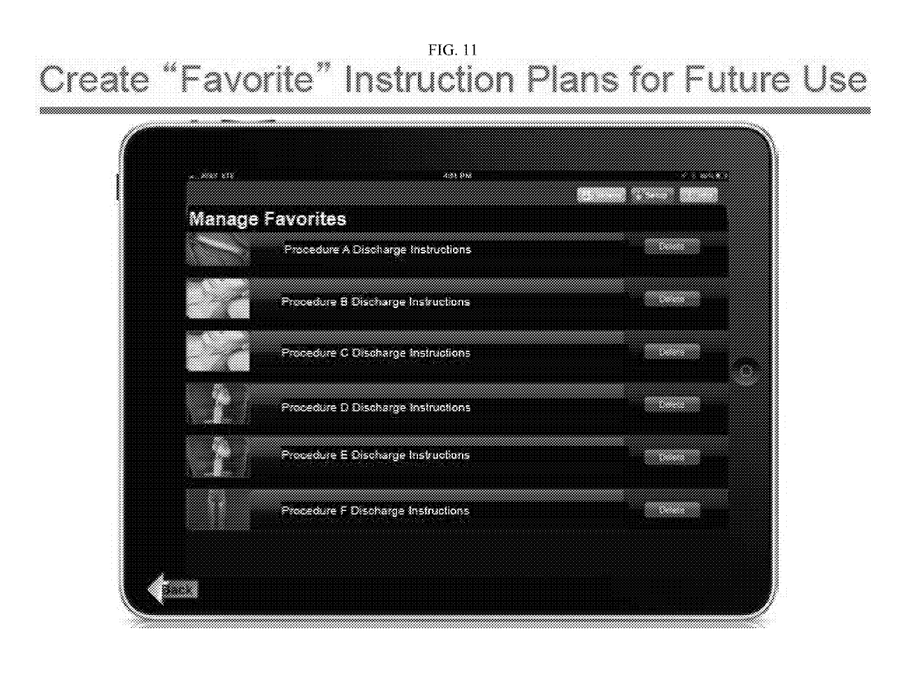

Referring again to FIG. 3, in step 300 the HCP can assemble the series of discrete instructions to compile a patient tutorial. These tutorials can be designed based on the operation type (e.g. angioplasty), or patient type (e.g. elderly) such that the HCP can save a given tutorial as a template which can be easily recalled and presented to a subsequent patient that belongs to the same demographic (e.g. elderly) or medical procedure (e.g. angioplasty) group (see FIG. 11). Additionally, the tutorial template can be “tweaked” by adding, or deleting, only select portions or discrete instructions. As such, the template can both provide a series of common instructions to minimize the time burden on the HCP in creating the tutorial, as well as provide the HCP with the flexibility to customize the final tutorial to meet the requirements of a specific patient.

Furthermore, an HCP can create a tutorial having a first presentation intended for an English-speaking patient, and the same set of instructions can be shown with a different presentation format to a second non-English speaking patient. Additionally, the instructions (whether text or audible) can be provided in multiple languages.

In step 400 the user or HCP can operate the user interface to display or play the tutorial, either as individual segments or as a sequence of instructions. The instructions provided in the tutorial can include graphical, audio, textual, and/or animated content. Similarly, the instructions provided in the tutorial can include prescription, nutritional, and/or educational information. Additionally, a quiz can be administered to the patient to assess their comprehension. The results of these quizzes can be analyzed to determine which instruction(s) are most effective at promoting patient understanding and compliance, and thus minimize risk of readmission, as discussed in further detail below. Additionally, the quizzes can be used to calculate a total score corresponding to the sum score of each of the answers selected, and determining the need for a post-discharge, and remote (i.e. outside of medical facility), medical care. For instances when the total score is below the threshold value an automated alert can be sent to the medical facility and/or patient's physician to proactively provide supplemental care and thereby pre-empt any readmission to the medical facility.

In step 500 the tutorial can be printed with the text and graphical instructions to further enhance patient comprehension. In step 600 an electronic mail agent within the user interface can automatically generate an email addressed to the patient, and their caregiver(s) if so desired, which includes a hyperlink to the URL address for the tutorial they reviewed at the HCP facility. As noted previously, given that the library instructions in this system are patient-anonymous data, the operation of this system and method does not present any challenges with respect to HIPAA compliance. Accordingly, steps 500 and 600 provide hard and electronic copies of the tutorial for the patient (and their caregiver(s), or additional medical facilities) to reference after discharge, thereby further improving comprehension and compliance.

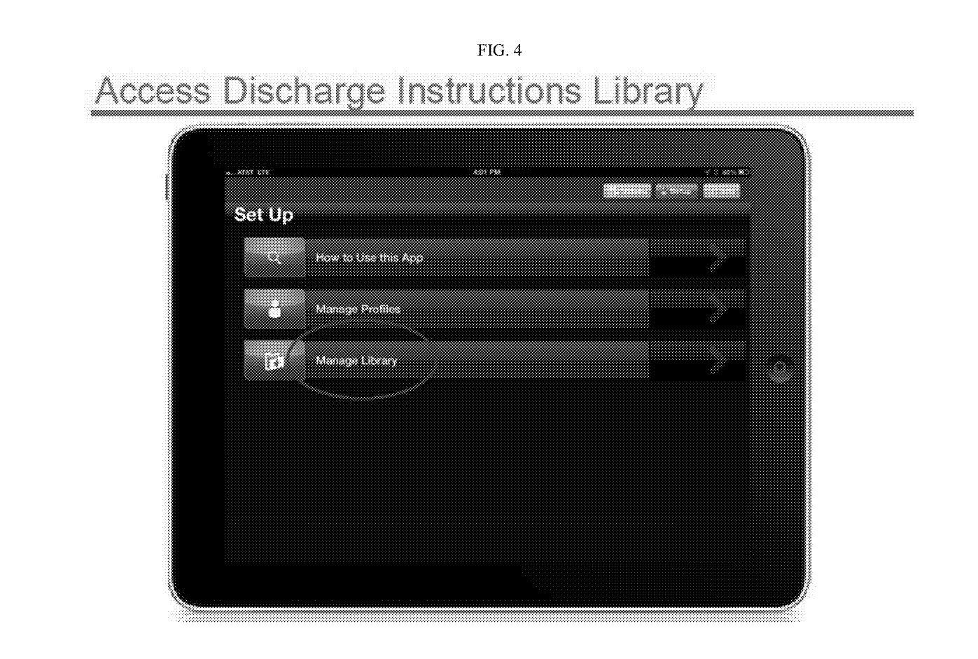

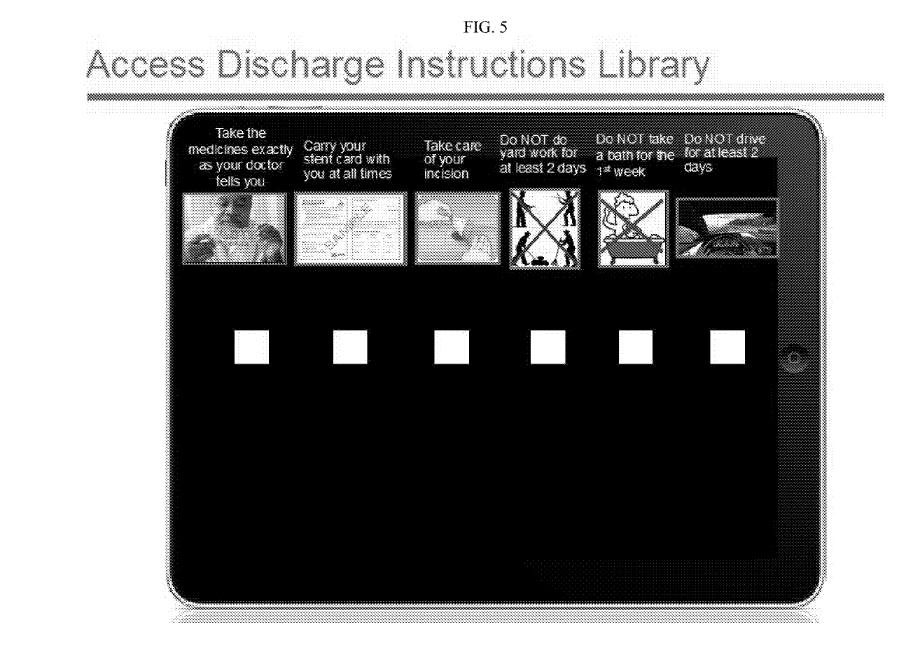

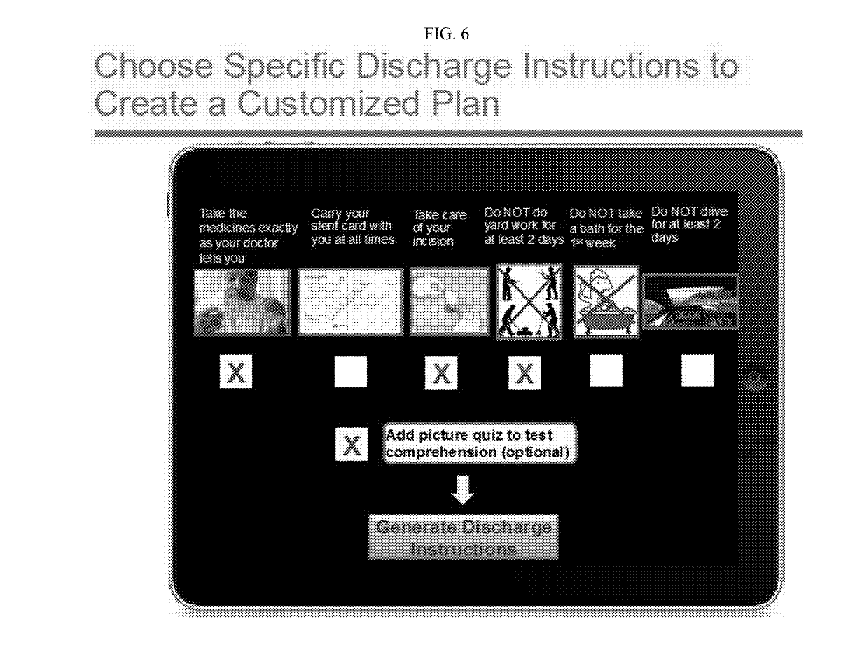

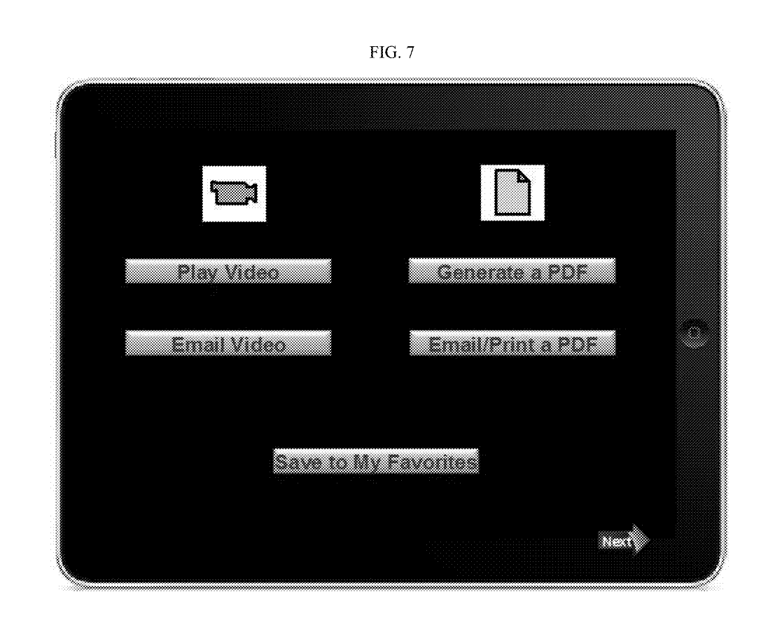

FIGS. 4-7 depict an exemplary embodiment of the interface a HCP interacts with to select instructions and assemble a tutorial. In FIG. 4 the HCP enters a set up screen and selects the “Manage Library” option. It is to be understood that each HCP can be provided with an account and login identification to access the library of instructions. As such, a single repository of instructions can be accessed by multiple HCPs, with each HCP able to create and save their own template(s) of instructions under their account. This allows for an HCP to login and quickly retrieve their template for a particular procedure (e.g. coronary artery bypass surgery) and then tailor select instructions to customize the tutorial to a specific patient, as described above. FIG. 5 depicts a representative library of instructions available to an HCP. In FIG. 6 the HCP selects (denoted by the “X” in the radio box below the icon) which instructions to incorporate into the tutorial for presentation to the patient. In other embodiments, the HCP will be presented with a “drag-and-drop” interactive screen which allows the HCP to drag discrete instructions from the library and drop them into a template (or a tutorial which is created “on the fly” and is not intended to be saved as a template). Additionally, the HCP can select the option to generate a quiz to test patient comprehension. In FIG. 7 the HCP is presented with a variety of options for presenting the tutorial to the patient.

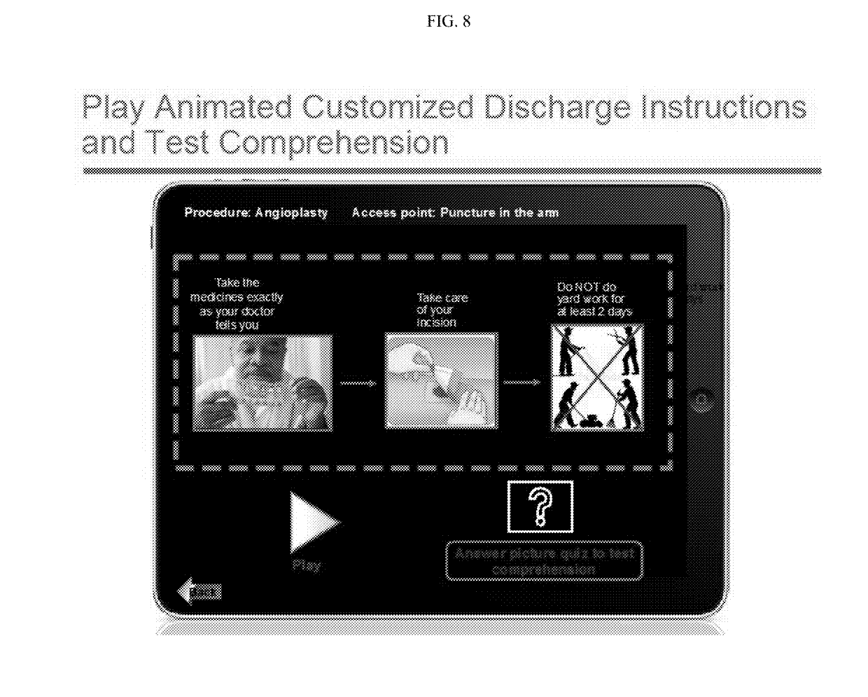

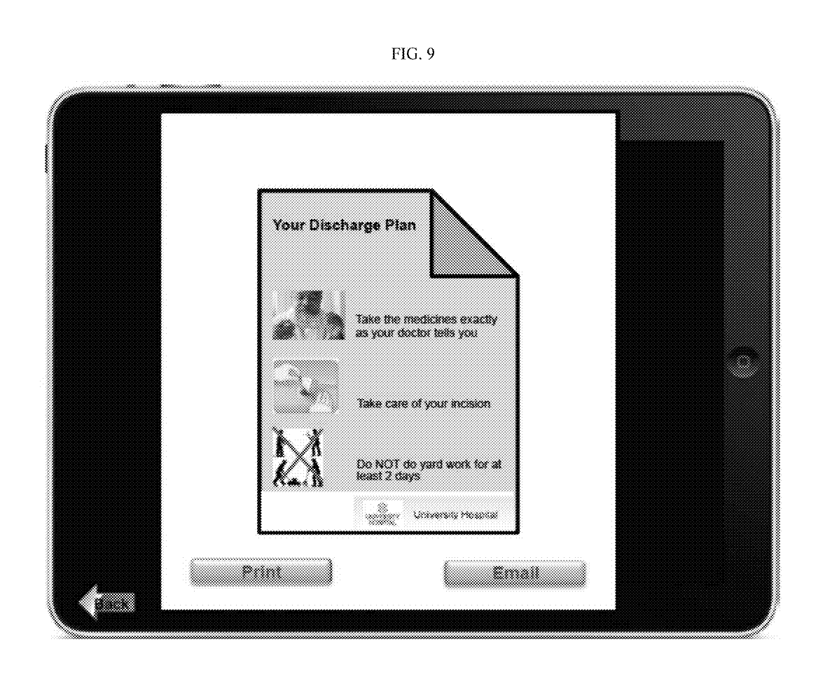

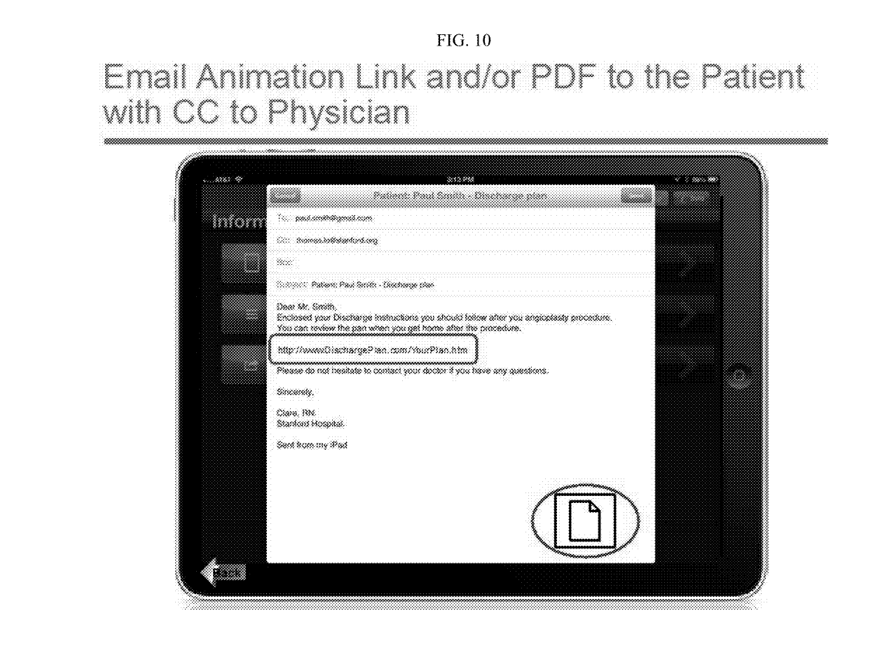

In some embodiments, the HCP is allowed to select more than one of these options such that the tutorial can be both viewed as a video on screen, and have a .pdf generated (for printing and/or email to patient). For example, FIG. 8 depicts an exemplary embodiment of the tutorial as viewed by the patient. FIG. 9 depicts the option presented to the HCP and/or patient for printing or emailing the assembled tutorial. FIG. 10 depicts a representative email (including the URL address to the tutorial as discussed above) which can be addressed to the patient and their caregiver(s) as well as the HCP.

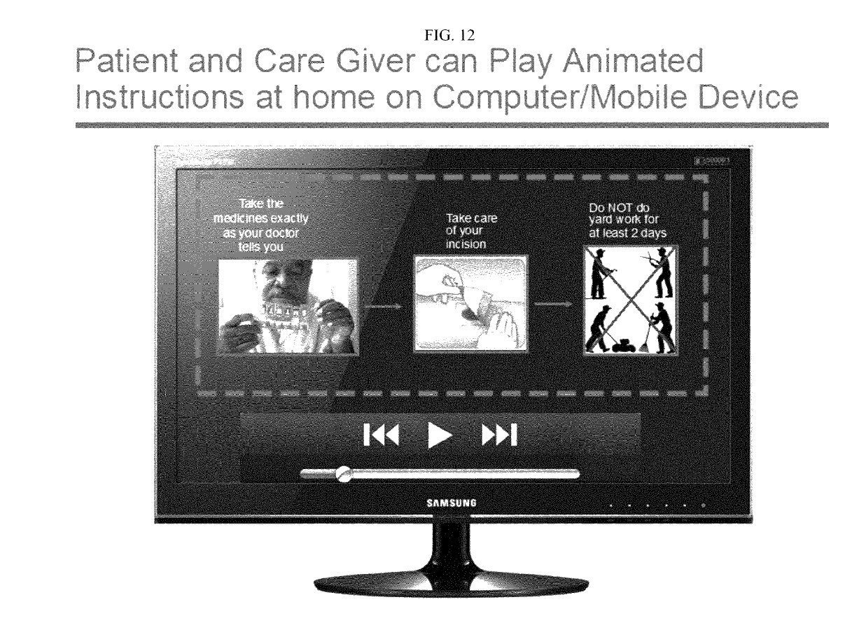

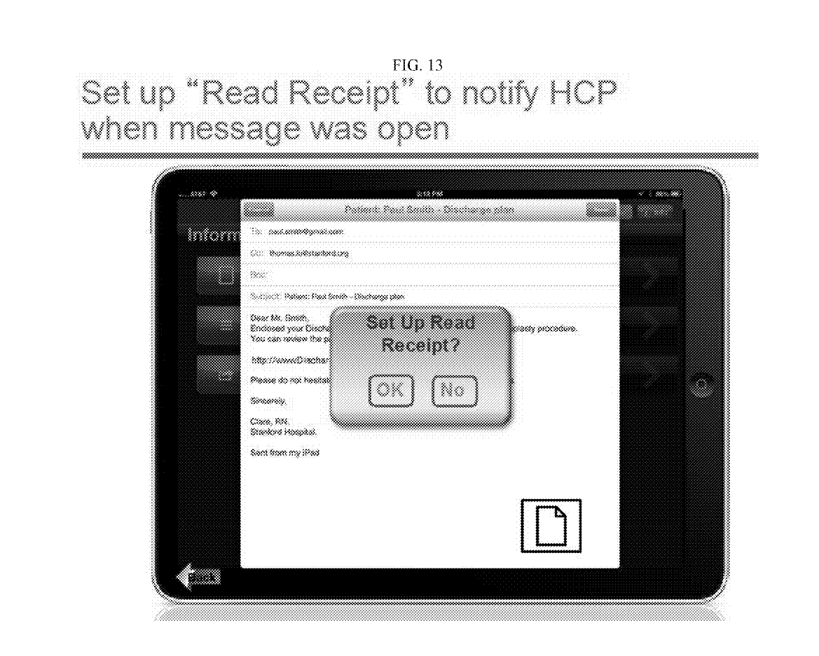

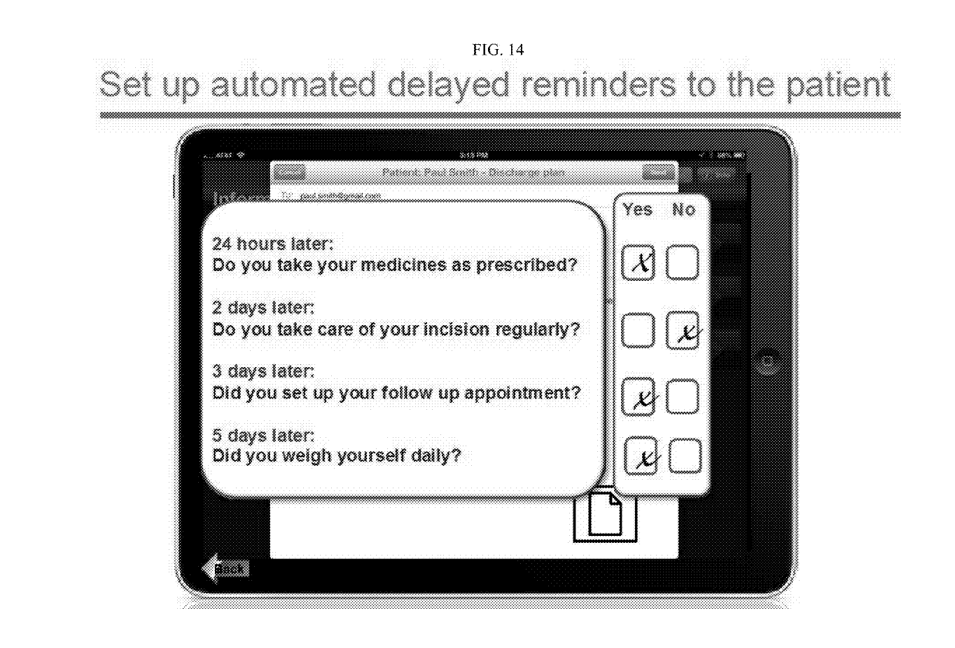

From this email, a patient or their caregiver(s) can recall and retrieve the complete tutorial remotely, once discharged from the health care facility. FIG. 12 depicts a representative reproduction of the tutorial on a patient's home television (though it is to be understood that the tutorial can be viewed on mobile devices as well). Additionally, and as depicted in FIG. 13, a read receipt functionality can be incorporated into the email agent so as to notify the HCP of when a message was opened and read by a patient or caregiver(s). Moreover, a calendar module can be incorporated into the system which provides for scheduled reminders to be automatically generated and sent to a patient or caregiver(s). FIG. 14 depicts an exemplary embodiment of such a reminder which includes a patient response section (e.g. “Yes” or “No”).

An analytics module (not shown) incorporated into the presently disclosed system allows for optimization of the tutorial content conveyed to the patient. For example, the analytics module can collect the results of the patient/caregiver(s) quizzes and perform a statistical analysis to determine which instruction(s) are most effective at promoting patient understanding and compliance, and thus minimize risk of readmission. In one embodiment, the analytics module can compile the patient/caregiver(s) response to the reminders (for instance as shown in FIG. 14) to determine which individual instructions and/or tutorials are most effective—i.e. which result in greatest patient/caregiver comprehension. The tutorial can be designed so as to require the patient or caregiver(s) to view each instruction/screen prior to advancing to the next instruction/screen.

According to an aspect of the present disclosure, the system may operate on a computer platform, such as a local or remote executable software platform, or as a hosted internet or network program or portal. As contemplated herein, any “computer platform” may be operable form any computing device as would be understood by those skilled in the art, including desktop or mobile devices, laptops, desktops, tablets, smartphones or other wireless digital/cellular phones, televisions or other thin client devices.

For example, the computer operable component(s) of the system may reside entirely on a single computing device, or may reside on a central server and run on any number of end-user devices via communications network. The computing devices may include at least one processor, standard input and output devices, as well as all hardware and software typically found on computing devices for storing data and running programs, and for sending and receiving data over a network, if needed. The computing device(s) may also be connected directly or via a network to remote databases, such as for additional storage backup, and to allow for the communication of files, email, software, and any other data format between two or more computing devices. The communications network can be a wide area network and may be any suitable networked system understood by those having ordinary skill in the art, such as, for example, an open, wide area network (e.g., the internet), an electronic network, an optical network, a wireless network, a physically secure network or virtual private network, and any combinations thereof. The communications network may also include any intermediate nodes, such as gateways, routers, bridges, internet service provider networks, public-switched telephone networks, proxy servers, firewalls, and the like, such that the communications network may be suitable for the transmission of information items and other data throughout the system.

Since the instruction library or repository consists of patient-anonymous data, the system is HIPAA compliant and does not require any encryption devices or algorithms. Additionally, the system may limit data manipulation, or information access. For example, a system administrator may allow for administration at one or more levels, such as at an individual user (patient) level, a healthcare professional level, or at a system level. A system administrator may also implement access or use restrictions for users at any level. Such restrictions may include, for example, the assignment of user names and passwords that allow the use of the present subject matter, or the selection of one or more data types that the subservient user is allowed to view or manipulate.

The system software may provide, for example, applications, such as the aforementioned discharge tutorial accessible to one or more users to perform one or more functions. Such applications may be available at the same location as the user, or at a location remote from the user. Each application may provide a graphical user interface (GUI) for ease of interaction by the user with information resident in the system. A GUI may be specific to a user, set of users, or type of user, or may be the same for all users or a selected subset of users. The system software may also provide a master GUI set that allows a user to select or interact with GUIs of one or more other applications, or that allows a user to simultaneously access a variety of information otherwise available through any portion of the system.

It is to be understood that the figures and descriptions of the presently disclosed subject matter have been simplified to illustrate elements that are relevant for a clear understanding of the present disclosure, while eliminating, for the purpose of clarity, many other elements found in hospital discharge decision systems and methods. Those of ordinary skill in the art may recognize that other elements and/or steps are desirable and/or required in implementing the present disclosure. However, because such elements and steps are well known in the art, and because they do not facilitate a better understanding of the present subject matter, a discussion of such elements and steps is not provided herein. The disclosure herein is directed to all such variations and modifications to such elements and methods known to those skilled in the art.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A method of iterating group-based tutorial content in an interactive tutorial, comprising:
displaying an interactive tutorial of a web-based application to a patient of a patient group having undergone a medical procedure, wherein the interactive tutorial includes a series of instructions for the patient group and a customized instruction for the patient, and wherein the instructions specify post-procedure care activities to recover from the medical procedure;
receiving an input of the patient in an interactive questionnaire of the web-based application, wherein the input indicates that the patient complied with a post-procedure care activity specified by the customized instruction;
determining, by an analytics module of the web-based application based on the input, that the customized instruction effectively promotes patient compliance;
modifying, automatically by the web-based application based on the determination, the series of instructions for the patient group to include the customized instruction; and
displaying the interactive tutorial of the web-based application to another patient of the patient group, wherein the interactive tutorial includes the modified series of instructions.
